(19) United States
(12) Patent Application Publication
(10) Pub. No.: US 2006/0048898 A1
(43) Pub. Date: Mar. 9, 2006

(54) Labeler

(75) Inventor: Kevin R. Christie, Valrico, FL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: FMC Technologies, Inc., Chicago, IL (US)

(21) Appl. No.: 11/218,941

(22) Filed: Sep. 2, 2005

Related U.S. Application Data
(60) Provisional application No. 60/607,376, filed on Sep. 3, 2004.

(51) Int. Cl. B65C 9/00

(52) U.S. Cl. 156/540; 156/556

(57) ABSTRACT

An improved labeler includes a label base and a label cassette. An electronically-controlled drive mechanism is contained within the labeler base housing and is operated intermittently to synchronously drive a mechanism for feeding labels to be picked up by an applicator head that is reciprocally movable along a linear axis and to be placed upon the articles being labeled.

### CROSS-REFERENCE TO RELATED PATENT APPLICATION

This patent application claims the benefit of priority to U.S. Provisional Application No. 60/607,376, filed Sep. 3, 2004, and entitled “Labeler,” which is incorporated in its entirety herein by this reference.

### FIELD OF THE INVENTION

The present invention relates to labelers generally, and more particularly, to labelers for the application of vinyl labels.

### BACKGROUND OF THE INVENTION

Labels are applied to fruit and vegetables in packing houses, where the speed at which the labels are applied, the accuracy of the label application, and the space required by the labeler, i.e. the labeler footprint, are important. Speed is important because the fruit must be packed and shipped quickly so that the shelf life in stores will be as long as possible. Accuracy, i.e. the successful application of the proper label to the fruit, is important for allowing the packing house to process produce with a label applied thereto and because packing house profitability is adversely affected when a label that would have permitted a higher selling price is not applied to fruit otherwise capable of commanding such higher price.

Space is important because of the physical configuration of any given packing house. The fruit can be transported in a series of lanes, each lane conveying fruit on a plurality of cradles connected to an endless belt, each cradle supporting and locating an individual fruit. The fruit in each lane is sized by conventional sizing means and subsequently conveyed past a plurality of labelers arranged in series or banks, each of the labelers in the series of labelers being loaded with a different label, i.e. a label imprinted with indicia to identify the size and variety of the fruit. The physical arrangement of the packing house often limits, without major reconstruction of the building, the number of banks of labelers it is possible to install.

One known type of labeler used to label fruit and vegetable includes an extendable bellows for placing the labels (see, e.g., U.S. Pat. No. 3,450,590 to LaMers and U.S. Pat. No. 4,547,252 to LaMers and EP 0113256 assigned to Sinclair). With this type of labeler, the bellows is moved past a magazine or cassette which dispenses the labels from a carrier strip. The labels are held in position on the end of the bellows by application of a vacuum to the bellows that is pulled through openings in the end of the bellows. The vacuum also serves to maintain the bellows in a retracted position. As the bellows is moved to an application position adjacent a fruit, positive pressure is applied and the bellows is extended to contact the fruit and apply the label thereto. Although the bellows-type labeler has many desirable advantages and features, such a labeler can be expensive.

### SUMMARY OF THE INVENTION

The present invention provides a labeler for applying labels to articles. The labeler can include a removable label cassette for delivering a supply of labels to the labeler, a feed mechanism for advancing the supply of labels through the labeler, a drive mechanism for operating the feed mechanism, and an applicator head having an end effector that is movable in a reciprocal fashion, via a linear actuator, for example, along an axis substantially perpendicular to the direction in which the object being labeled is transported.

In other aspects of the invention, a labeler can be provided having multiple applicator heads for conveniently labeling trays, for example. In yet other aspects of the invention, the applicator head can be mounted to a carriage that is movable along a track across the width of a conveyor. The carriage can be moved along a predetermined path based upon the type of tray being used to transport the fruit to label each piece of fruit housed in the tray.

The features of the present invention will become apparent to one of ordinary skill in the art upon reading the detailed description, in conjunction with the accompanying drawings, provided herein.

### BRIEF DESCRIPTION OF THE DRAWINGS

FIG. 1 is a perspective view of an embodiment of a labeler system according to the present invention from a first side thereof.

FIG. 2 is a top plan view of the labeler system of FIG. 1.

FIG. 3 is a side elevational view of the labeler system of FIG. 1 from the first side thereof with a cover mounted thereto.

FIG. 4 is a perspective view of the labeler system of FIG. 1 from the first side thereof similar to FIG. 3 but with a lid of the cover in an open position.

FIG. 5 is a perspective view of an embodiment of a labeler according to the present invention for use with the labeler system of FIG. 1.

FIG. 6 is a first side elevational view of the labeler of FIG. 5 with a supply of labels inserted therein.

FIG. 7 is a perspective view of a base of the labeler of FIG. 5.

FIG. 8 is a side elevational view of the labeler base of FIG. 7.

FIG. 9 is a top plan view of the labeler base of FIG. 7.

FIG. 10 is a perspective view of the labeler base of FIG. 7 with cover plates thereof removed for illustrative purposes.

FIG. 11 is a side elevational view of an end effector of the labeler base of FIG. 7.

FIG. 12 is a perspective view of a body of the end effector of FIG. 11.

FIG. 13 is a side elevational view of the body of FIG. 12.

FIG. 14 is a distal end view of the body of FIG. 12.

FIG. 15 is a perspective view of a boot of the end effector of FIG. 11.

FIG. 16 is a distal end view of the boot of FIG. 15.

FIG. 17 is a side elevational view of the boot of FIG. 15.

FIG. 18 is a perspective view of a cassette of the labeler of FIG. 5.

FIG. 19 is a top plan view of the labeler cassette of FIG. 18.

FIG. 20 is a bottom plan view of the labeler cassette of FIG. 18.

FIG. 21 is a perspective view of a scallop wheel assembly of the labeler cassette of FIG. 18.

FIG. 22 is a perspective view of a separator of the cassette of FIG. 18.

FIG. 23 is a plan view of the separator of FIG. 22.

FIG. 24 is a flowchart depicting the actuation sequence of the end effector of the labeler of FIG. 5.

FIG. 25 is a perspective view of another embodiment of a labeler system according to the present invention.

FIG. 26 is an end elevational view of the labeler system of FIG. 25.

FIG. 27 is a top plan view of the labeler system of FIG. 25.

FIG. 28 is a perspective view of an applicator assembly of the labeler system of FIG. 25.

FIG. 29 is a perspective view of an air-driven label feed mechanism from a first side thereof.

FIG. 30 is a perspective view of the label feed mechanism of FIG. 29 from a second side thereof.

### DETAILED DESCRIPTION OF EMBODIMENTS OF THE INVENTION

In accordance with the teachings of an embodiment of the present invention, there is provided a labeler which includes an applicator head having an end effector that is movable in a reciprocal fashion, via a linear actuator, for example, along an axis substantially perpendicular to the direction in which the object being labeled is transported. The end effector can selectively move to pick a label from a carrier strip, for example, and to place that label on an object, such as a piece of fruit. A vacuum source can be operably arranged with the end effector and selectively operated to act on the label so picked through a plurality of holes in the end effector to facilitate the its ability to pick up the label. When the end effector has placed the label on the object being labeled, the vacuum source can be discontinued to allow the label to remain on the object once the end effector returns to its home position. The end effector can also be operably arranged with a source of compressed air that can be directed through the holes of the end effector to facilitate removal of the label from the end effector and to clear any debris that may accumulate on the end effector.

One or more labelers according to the present invention can be ganged together to comprise a labeler system for the ready labeling of trays of fruit, for example. In other embodiments a single labeler can be used for labeling. In yet other embodiments, one or more labelers can be movably mounted such that such labeler(s) can travel over a predetermined path and apply labels to multiple objects along the path.

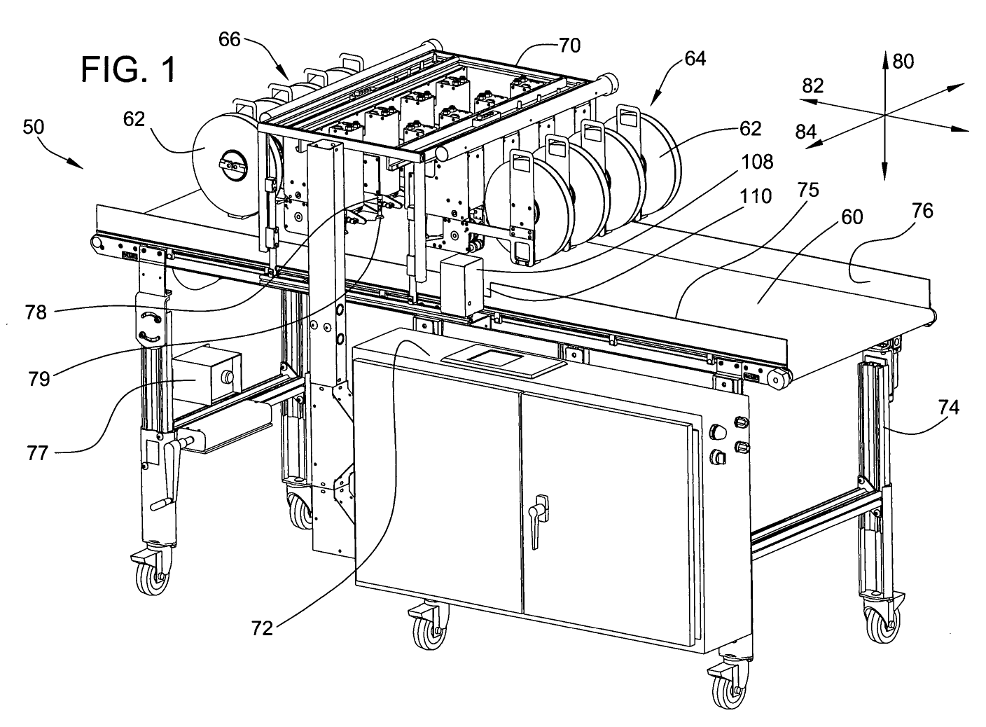

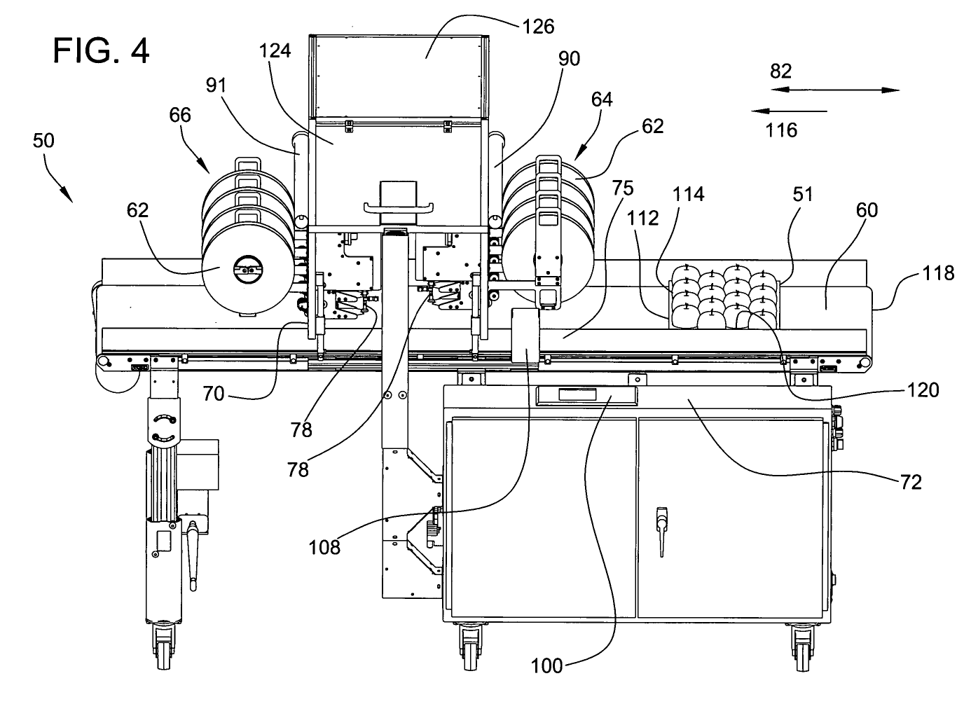

Referring to FIGS. 1-4, an embodiment of a labeler system 50 according to the present invention is shown. The labeler system 50 is useful for labeling a tray 51 of fruit (FIG. 4) which contains multiple rows of fruit ready for labeling. The tray 51 shown in FIG. 4 holds sixteen pieces of fruit arranged in a 4×4 array. It will be understood that the labeler system 50 can be used to label fruit packed differently, such as, in other sizes of trays, and that other labelers and labeler systems according to the present invention can be used to label a tray having a 4×4 array.

Referring to FIG. 1, the labeler system 50 can include a conveyor 60 for moving a succession of trays into position for applying labels to the fruit in the trays, a plurality of labelers 62 arranged in this embodiment in a first bank 64 of four labelers and a second bank 66 of four labelers, a frame 70 mounted to the conveyor 60 for supporting the first and second banks 64, 66 of labelers such that they depend from the frame 70 over the conveyor 60, and a controller 72 for operating the labeler system 50.

The conveyor 60 can be supported by a plurality of legs 74 that are adjustable such that the height of the conveyor 60 can be changed. The conveyor 60 can include a pair of sidewalls 75, 76 in spaced relation to each other. The conveyor can be selectively operated via a separate controller 77, which can be used to vary the speed and to stop or start the conveyor.

The labelers 62 can be substantially identical to each other. The labelers 62 of the first bank 64 are disposed in opposing relationship to the labelers 62 of the second bank 66. As described in greater detail below, each labeler 62 includes an applicator head 78 having a linearly-reciprocating piston with an end effector 79 mounted to its distal end that is movable along an applicator axis that, in this case, is parallel to a vertical Z axis 80. The conveyor 60 can move the trays toward the labelers 62 along a longitudinal X axis 82. Each of the labelers 62 is independently movable along a transverse Y axis 84 via the controller 72. The X, Y, and Z axes 80, 82, 84 are mutually perpendicular to each other.

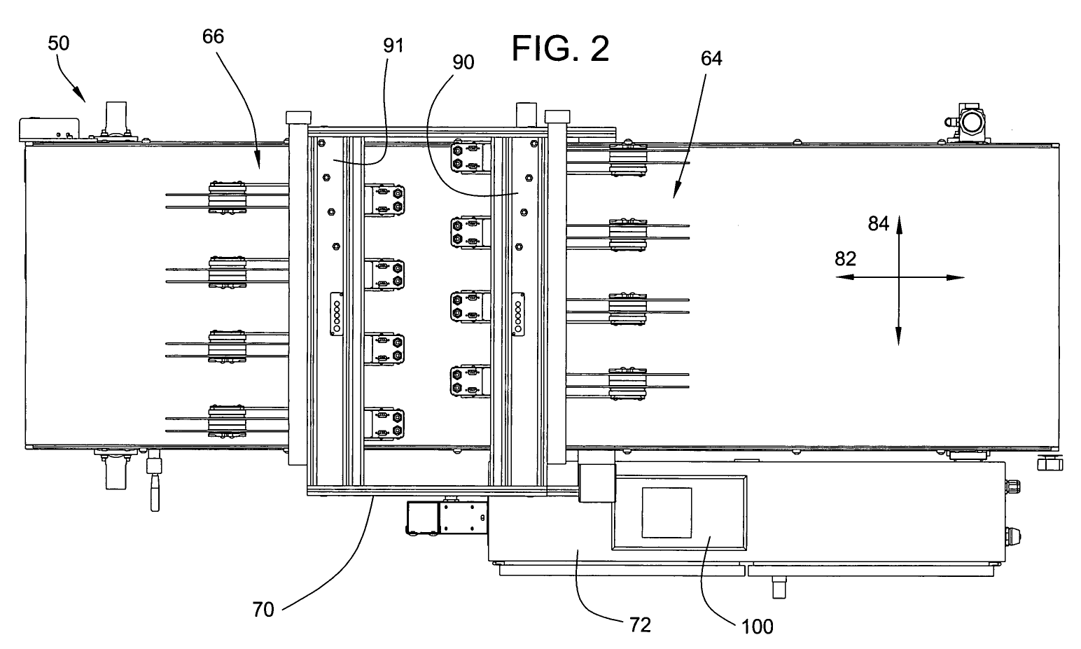

The frame 70 can include a hydraulic assembly for variably adjusting the vertical position of the labelers 62 relative to the conveyor 60. Referring to FIG. 2, the frame 70 can include a pair of transverse tracks 90, 91 disposed along the transverse axis 84, with the first and second banks 64, 66 of labelers 62 being respectively mounted to each of the tracks 90, 91 such that the labelers are movable along the tracks parallel to the transverse axis 84.

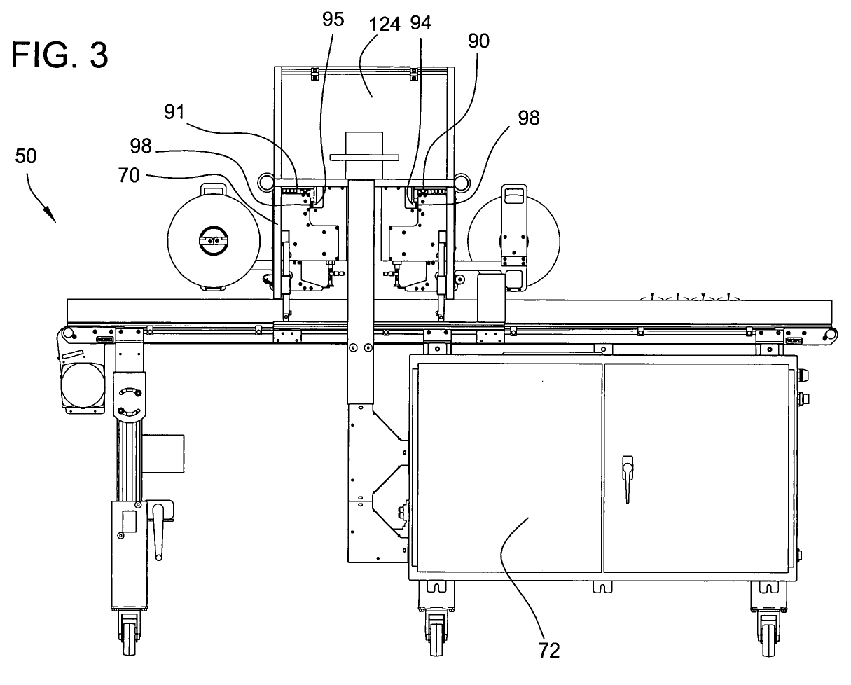

Referring to FIGS. 2 and 3, each of the tracks 90, 91 can include a gear rack 94, 95 for meshingly receiving a motor-driven, rotatable adjuster gear 98 of each of the labelers 62. The motor of each labeler can be controlled via the controller 72 to rotate the adjuster gear 98 in either of two opposing directions. The adjuster gear 98 can rotatingly engage the gear rack in which it is enmeshed to translate the labeler along the transverse axis 84. The controller 72 can independently drive the adjuster gears in the gear racks to allow the labelers to be independently adjustable along the tracks to vary their positions with respect to each other along the transverse Y axis 84, for example, in order to substantially align the applicator heads 78 with a respective row of a tray loaded on the conveyor 60 to be labeled.

The controller 72 includes an operator interface 100 in the form of a touch screen. The controller 72 can include a database of labeler positions for a variety of trays selected for use with the labeler system 50. An operator can use the operator interface 98 to select the type of tray being used with the labeler system 50 for labeling the items packaged in the tray. Selecting the tray on the operator interface screen 100 delivers an input signal to the controller 72, which, in turn, positions the first and second banks 64, 66 of labelers to a predetermined location suitable for use with the tray selected. The controller can monitor the location of each of the labelers along the respective transverse tracks via any suitable sensing means, such as, an encoder, for example.

Referring to FIG. 4, the controller 72 can detect the presence of a tray on the conveyor. The controller 72 includes a pair of sensors mounted in an enclosure 108 positioned at a cutout 110 in the first sidewall 75 of the conveyor 60 configured to allow the sensors access to the conveyor belt (FIG. 1). The controller 72 can also include an encoder operably arranged with the conveyor 60 to allow the controller to monitor the movement of the conveyor, and thus the position of the tray 51 on the conveyor 60 relative to the banks 64, 66 of labelers. The sensors and the applicator heads of each of the labelers are in known fixed positions with respect to the longitudinal axis 82 by virtue of their being mounted to the conveyor 60 and to the transverse tracks 90, 91, respectively. One of the sensors is positioned to detect a leading edge 112 of the tray 51, and the other sensor is positioned to detect a leading object 114 inserted therein, as the tray 51 moves in a labeling direction 116 along the longitudinal X axis 82 from a loading end 118 of the conveyor.

In the produce industry, it is fairly typical to have two styles of a particular size of tray to allow for the trays to alternatingly nest within each other when loaded with produce. In these two styles of a particular tray, the distance between the leading edge of the tray and the location of a leading object placed in the tray is different. The combination of the tray sensor and the object sensor in conjunction with the encoder can allow the controller 72 to determine the amount of distance between the leading edge 112 of the tray 51 and the leading object 114 in the tray 51 to determine which style of tray is moving down the conveyor 60 for labeling.

In other embodiments of the present invention, the controller can include a tray database that also includes the particular style of tray as well as type, and only a single sensor is used. In yet other embodiments, each labeler is provided with its own sensor that is used to detect the presence of an object to be labeled such that when the sensor senses an object, it provides an input signal to the controller which in turn directs the applicator head of the labeler to pick-and-place a label.

Referring to FIG. 4, in use, the operator can load the tray 51 being labeled onto the conveyor 60 such that a side 120 of the tray is disposed against one of the sidewalls of the conveyor 60, the first sidewall 75 in this example, such that the tray 51 is placed in a predetermined position relative to the transverse axis 84. In other embodiments, one of the sidewalls of the conveyor can include a groove or other track into which a mating, complementary flange of the tray can fit such that the tray is fixed with respect to the sidewall of the conveyor relative to the transverse axis 84.

Referring to FIG. 4, the controller 72 can initiate a labeling sequence with the labelers 62 according to the size of the tray input by the operator via the operator interface 100 and the type of tray detected by the sensors. The controller 72 monitors the relative position of the tray 51 with respect to the labelers as the conveyor 60 moves the tray along the longitudinal axis 82 underneath the banks 64, 66 of labelers. The controller 72 can selectively operate the applicator heads 78 of the labelers to pick a label from its supply and apply it to the objects in the tray 51. In the illustrative example, each applicator head 78 labels two objects of the 4×4 array, with the labelers 62 of the first bank 64 labeling the first and third row of the tray 51, and those of the second bank 66 labeling the second and fourth rows.

In this embodiment, each bank includes four labelers such that a separate labeler is for each column of a tray with a 4×4 array. It will be appreciated, however, that other combinations are possible, including adding more banks of labelers or only one bank, adding more labelers to each bank, running a tray through the labeling system multiple times to label each object loaded in the tray, etc. In instances where a tray smaller than a 4×4 array is loaded onto the conveyor 60, one or more of the labelers can remain idle during the labeling sequence.

Referring to FIGS. 3 and 4, the labeler system 50 is shown with a cover 124 mounted over the frame 70. In FIG. 4, a lid 126 of the cover 124 is shown in an open position to allow access to the frame 70 and to the top portion of the labelers.

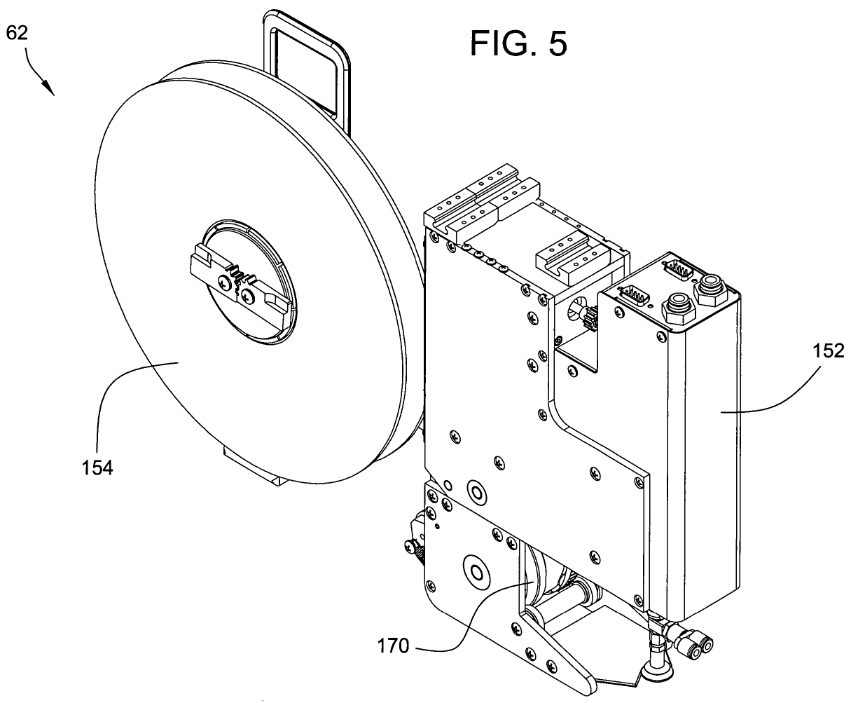

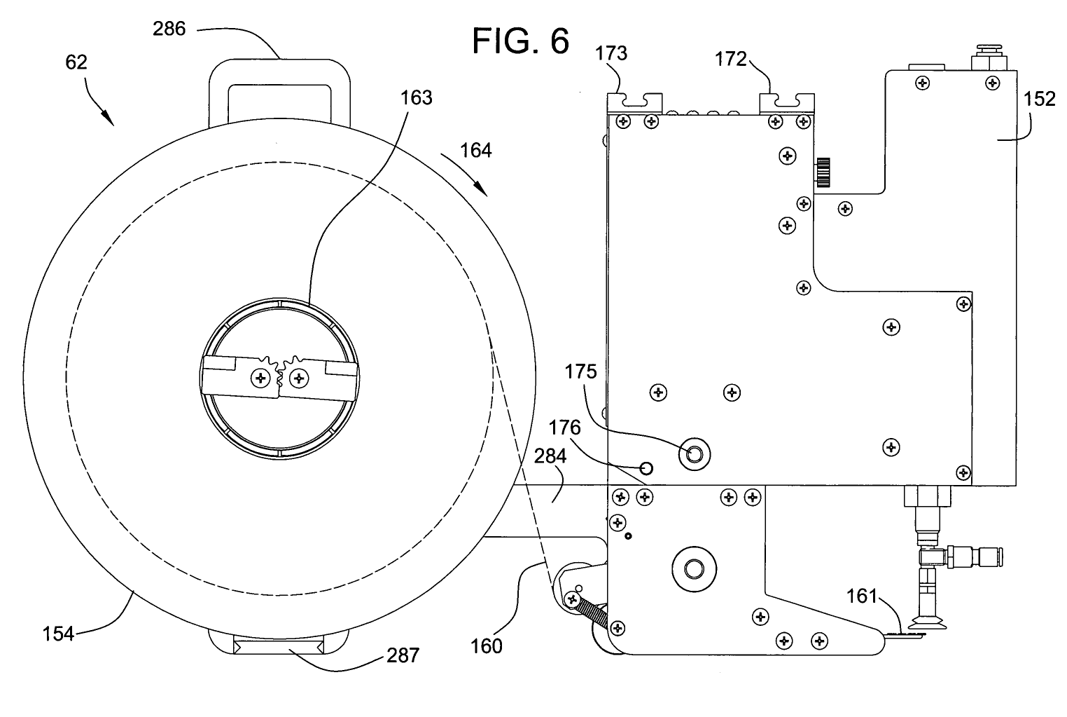

Referring now to FIGS. 5 and 6, there is shown an illustrative labeler 62 for applying labels to articles such as fruit or vegetables constructed in accordance with the teachings of the present invention. The description of the illustrative labeler 62 is applicable to all of the labelers of the labeler system 50 of FIG. 1.

Referring to FIG. 5, the illustrated labeler 62 includes a labeler base 152 and a label cassette 154 in removable engagement therewith. The label cassette 154 is releasably retained on the labeler base 152, and different cassettes are interchangeable for convenient use with the same drive. As shown in FIG. 6, the label cassette 154 can further include a conventional label carrier strip 160 having a plurality of labels 161 adhesively carried thereon, which is wound on a rotatable reel 163 of the cassette 154. The reel 163 is supported so that it is free to rotate in a dispensing direction 164 to apply labels to the fruit but prevented from rotating in the opposing direction. The reel 163 can be removably mounted. While one cassette is operatively engaged with the labeler base 152, other cassettes can be loaded off-line with additional carrier strips to facilitate the application of labels via the labeler 62 by having a ready supply of labels for application by the labeler 62. In addition, other cassettes can be at the ready in the event that a different sized label is to be applied. Additional details regarding the presently illustrated labeler can be similar to those provided in U.S. patent application Ser. Nos. 09/187,441 and 09/453,757, the disclosures of which are incorporated in their entireties herein by this reference.

Referring to FIG. 5, for feeding labels to a pick position for application to the object being labeled, the label cassette 154 can include a label feed mechanism 170. The label feed mechanism 170, described in greater detail below, can incorporate conventional technology usable in bellows-type labelers, such as those described in the above-referenced patent documents.

Referring to FIG. 6, the labeler base 152 can include a pair of slide mounts 172, 173 for mounting the base 152 to the frame 70 of FIG. 1 such that the labeler can be suspended over the conveyor 60, a cassette hanger rod 175 for supporting the cassette 154, and a pair of dowel pins 176 for retentive engagement with the cassette to rotatively fix the cassette with respect to the base.

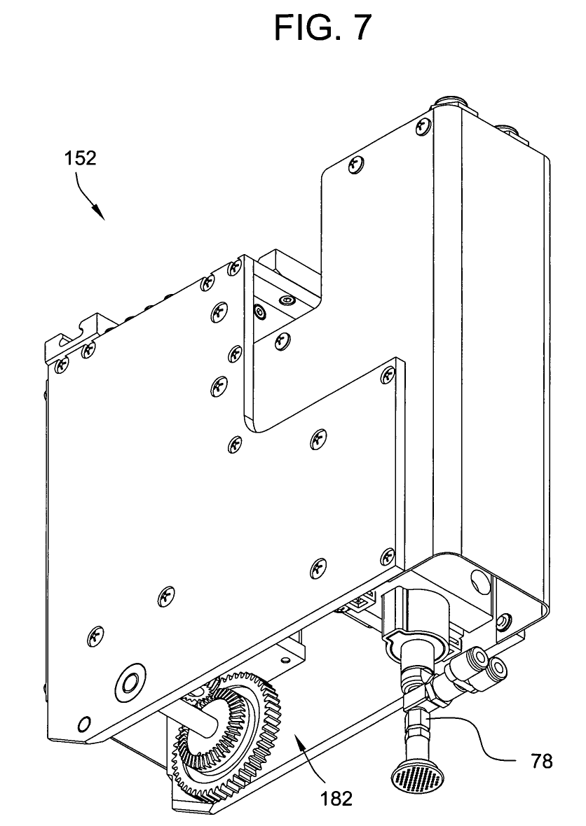

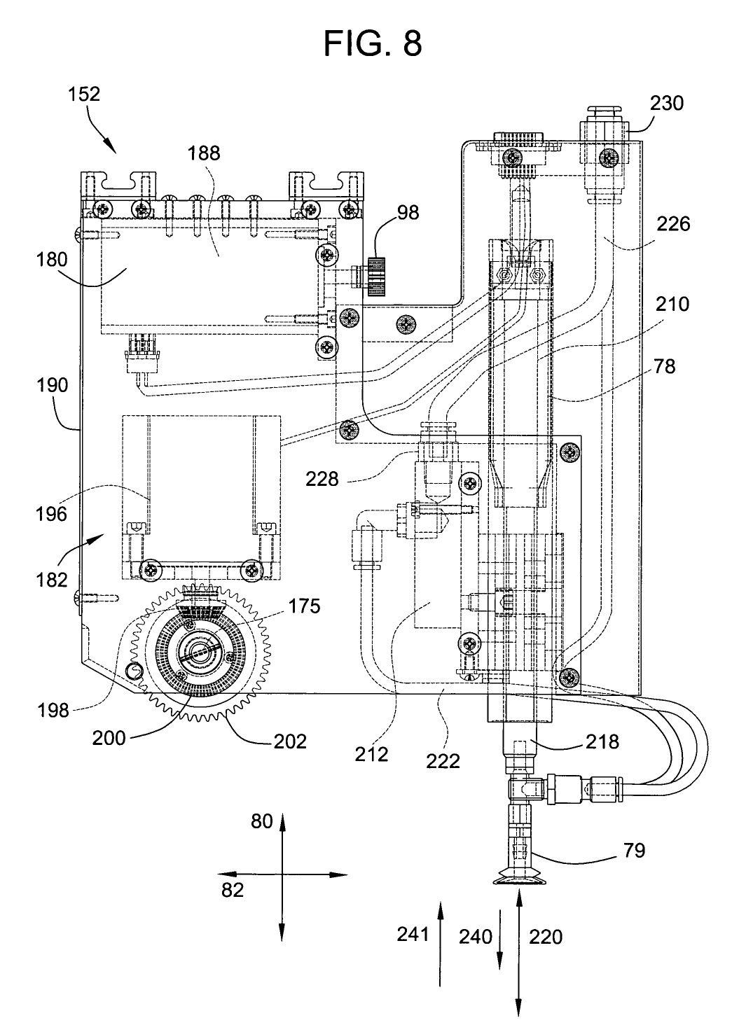

Referring to FIGS. 7 and 8, the base 152 can also include an adjustment mechanism 180 to selectively change the position of the labeler on the transverse track to which it is mounted in the labeler system 50 of FIG. 1, a drive mechanism 182 operably engageable with the label feed mechanism 170 of the cassette to advance the supply of labels from the cassette, and the applicator head 78 to selectively pick and place labels.

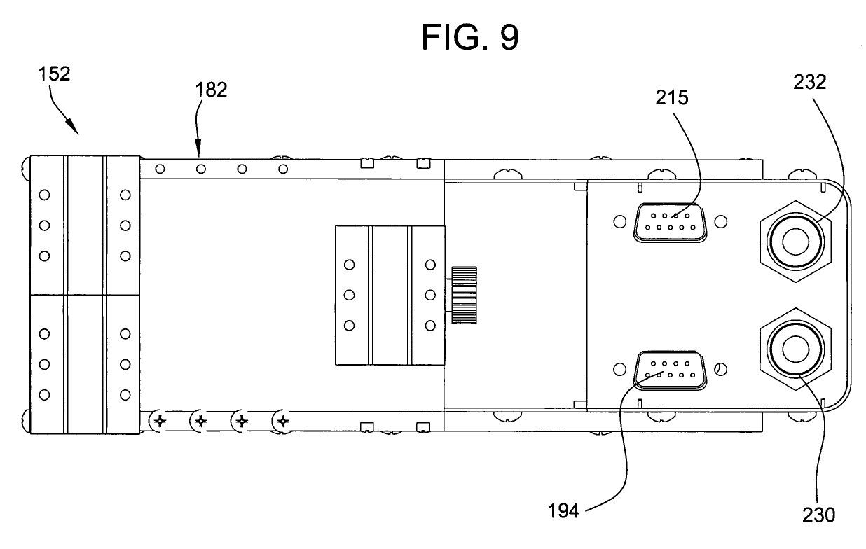

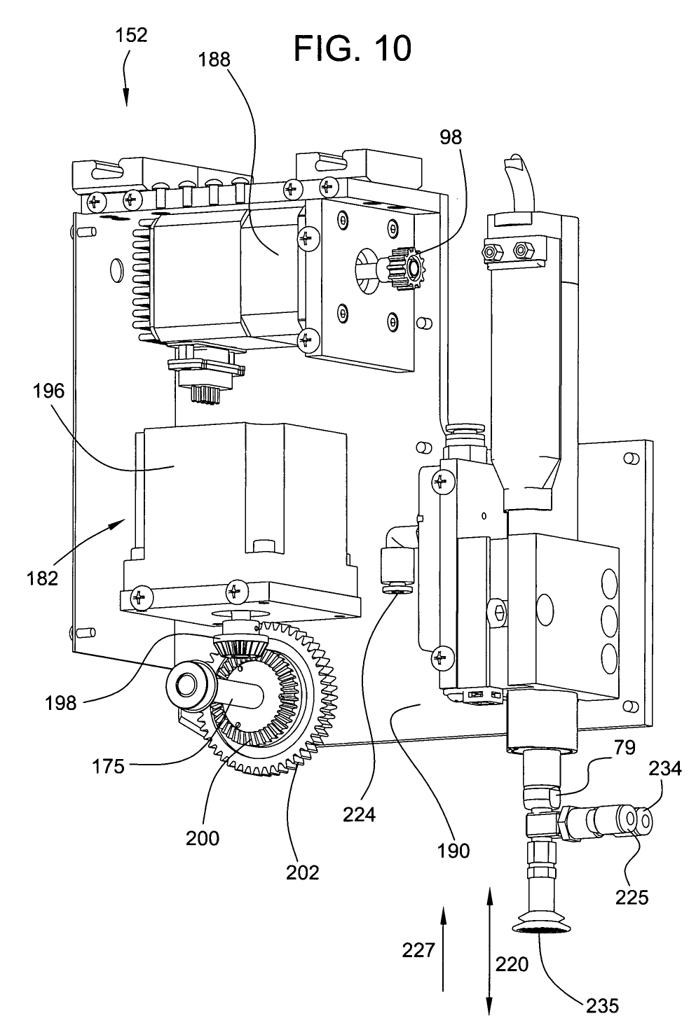

Referring to FIGS. 8 and 10, the adjustment mechanism 180 of the base 152 can include a the adjuster gear 98 and a motor 188, such as a stepper motor, for example, for operating the adjuster gear 98 for use in the tray labeler system. The motor 188 can be operated in either direction to rotate the adjuster gear 98, which can be operatively engaged with the gear rack, to adjust the position of the labeler along the transverse Y axis 84 in the respective direction which the motor 188 is operated. The motor 188 can be disposed within a base housing 190 which defines an interior cavity (FIG. 8). The adjuster gear 98 can extend from the base housing 190. The motor 188 can be electrically connected to the controller via a first electrical connector 194 (FIG. 9).

Referring to FIG. 9, the drive mechanism 182 can be electrically linked to the controller for selective operation thereof by the first electrical connector 194. Referring to FIGS. 8 and 10, the drive mechanism 182 can include a motor 196, such as a servo motor or a stepper motor, for example, and a drive gear 198 operably arranged with the motor 196 such that the motor 196 can rotate the drive gear 198. In this embodiment, the motor 196 is a stepper motor. The drive mechanism 182 can also include an intermediate gear 200 and a feed gear 202 that can be rotatably supported by the cassette hanger rod 175, which is journaled to the housing 190. The drive gear 198 is enmeshed with the intermediate gear 200. The intermediate gear 200 and the feed gear 202 are rotatively coupled together such that they rotate together.

The stepper motor 196 can be selectively operated to rotate the drive gear 198 of the drive mechanism 182 which in turn rotates the intermediate gear 200 that is coupled with the feed gear 202 to rotate it. The feed gear 202 is, in turn, enmeshed with a gear of the label feed mechanism 170. The rotation of the feed gear 202 advances the label feed mechanism to unwind the carrier strip from the reel to sequentially advance labels to a pick position, wherein the applicator head 78 can pick up the label and apply it to an object being labeled. The stepper motor 196 can be controlled by the controller such that the stepper motor 196 is operable to selectively control the label feed mechanism upon the controller receiving an input from one or more sensors that an object is in a predetermined location to be labeled so that the drive mechanism 182 operates in order to feed the carrier strip through the feed mechanism.

Referring to FIG. 8, the applicator head 78 can include a linear motion actuator 210, a vacuum source 212, and the end effector 79. The linear motion actuator 210 can be selectively controlled via the controller to move in a reciprocal fashion. The linear motion actuator 210 is substantially continuously adjustable such that the actuator 210 can be disposed in a range of positions between a fully retracted position (shown in FIG. 8) and a fully extended position. The actuator 210 can be any suitable linear-acting device, such as a linear servo from LinMot designated as part number P01-23×160/40×100, for example. Referring to FIG. 9, the linear motion actuator 210 can be electrically connected to the controller for selective operation thereof by a second electrical connector 215.

The actuator 210 can have a linearly-reciprocating piston 218, with the end effector 79 mounted to the distal end thereof. The piston 218 is selectively movable over a predetermined range of travel in either direction between the fully retracted position and the fully extended position to define an applicator axis 220. The piston 218 can support the end effector 79 to selectively move the end effector in a reciprocal fashion along the applicator axis 220. The applicator axis 220 can be substantially parallel to the vertical Z axis 80 and perpendicular to the longitudinal X axis 82, along which the object to be labeled travels, via movement of the conveyor, for example. In other embodiments, the applicator axis can be disposed in other relationships to the axis along which the object to be labeled travels.

Referring to FIG. 8, the vacuum source 212, in this case, is in the form of a vacuum air generator, and is provided for generating a vacuum at the end effector to facilitate the removal of the label in the pick position from the carrier strip. The end effector 79 can be operatively connected to the vacuum generator 212 via a line 222 extending between an output port 224 of the vacuum generator 212 and a first input port 225 of the end effector 79 (FIG. 10). A second line 226 extends between an input port 228 of the vacuum generator 212 and a first connector port 230 extending from the base housing 190 (FIG. 9). An air source (not shown), such as a compressor, for example, can be connected to the vacuum generator 212 via connection to the first connector port 230 to provide an air supply for operating the vacuum.

Referring to FIGS. 9 and 10, the air source can also be connected to a second connector port 232 to supply a source of pressurized air to the end effector 79. Another line (not shown) can extend between the second connector port 232 and a second input port 234 of the end effector 79.

Referring to FIG. 10, the end effector 79 can include a plurality of holes 235 therein for allowing the vacuum source and the pressurized air to act upon the label being picked and placed. The first and second input ports 225, 234 of the end effector comprise parts of a Y-branch fitting that is associated with the end effector to selectively generate either a vacuum through the generator and the first input port 225 to facilitate the adhesion of the label to the end effector or a burst of air through the end effector by way of the second input port 234 to urge the label to separate from the end effector 79 to facilitate the label's application to the piece of fruit or other object being labeled.

Referring to FIG. 8, the end effector 79 can be provided to selectively pick a label from the carrier strip in the pick position and place it on the fruit or other article being labeled. To pick up a label, the controller can drive the actuator 210 through a picking sequence by moving it, for example, from a predetermined home position to move the end effector 79 along the applicator axis 220 in an application direction 240. The end effector 79 can move toward the label disposed in the pick position and stop such movement once the end effector 79 has sufficiently engaged the label. In some embodiments, this can be accomplished by moving the end effector 79 from a predetermined home position over a range of travel to a predetermined capture position, wherein the end effector 79 is disposed relative to the label in the pick position such that the end effector is in engaging relationship thereto. In other embodiments, the labeler can be equipped with a sensor that can be configured to detect when the end effector 79 is in sufficient contacting relationship with the label in the pick position. The sensor can be electrically connected to the controller so that the sensor can send an input signal thereto upon detecting such a situation. Upon receiving the input signal, the controller can direct the actuator to stop moving the piston.

For example, the end effector can move from the home position toward the label in the pick position. A vacuum sensor arranged with the vacuum generator 212 can monitor the vacuum generated thereby during movement of the linear motion actuator. The vacuum sensor can signal the controller once it detects an increase in vacuum to a specified range that corresponds to the end effector being in sufficient contacting relationship with the label. The controller can in turn signal the linear actuator 210 to continue to the application sequence.

Referring to FIG. 8, the vacuum generator 212 can provide a vacuum source at the end effector 79 during all or a part of the picking sequence, but is preferably providing a vacuum source once the end effector is in sufficient contacting relationship with the label in the pick position to allow the label to adhere to the end effector and separate from the carrier strip. The end effector 79 can act upon the label disposed in the pick position such that when the end effector 79 is moved in a retraction direction 241 along the applicator axis 220 (FIG. 8 also), the label can be lifted from the carrier strip, overcoming the slight adhesive connection between the label and the carrier strip. In some embodiments of the picking sequence, the actuator 78 can move the end effector 79 in the retraction direction 241 until the end effector 79 is back in the home position. In other embodiments of the picking sequence, the end effector need not move in the retraction direction 241 at all after coming into sufficient contacting relationship with the label in the pick position, but rather continues directly to the application sequence, moving in the application direction.

Referring to FIG. 8, the vacuum source 212 can be controlled via the controller to allow the label to be applied to the object. The linear motion actuator 72 can move the end effector through an application sequence by moving it, for example, in the application direction 240 to place the label on the fruit or other object. The end effector 79 can move toward the object to be labeled and stop such movement once the end effector 79 has sufficiently engaged the object.

In some embodiments, this can be accomplished by moving the end effector to a predetermined application position. In other embodiments, a sensor can be arranged with the actuator 210 to sense when the end effector 79 contacts the fruit, such as by sensing the current draw of the actuator 79 as previously described. This sensor can signal the controller to stop driving the actuator upon sensing a predetermined condition, thereby stopping the movement of the end effector 79 in the application direction 240. In those embodiments using a sensor to determine when the end effector is sufficiently engaged with the fruit to be labeled, the end effector can be placed in an application position that can vary depending upon the size of the fruit to be labeled.

Once the end effector is in the application position, the controller can cut off the vacuum source to cease its acting upon the label picked up by the end effector. The controller can then direct the source of pressurized air to flow through the second input port 234 of the end effector 79 to provide a blast of air against the label held by the end effector, thereby facilitating the removal of the label from the end effector and its application on the fruit or other object being labeled.

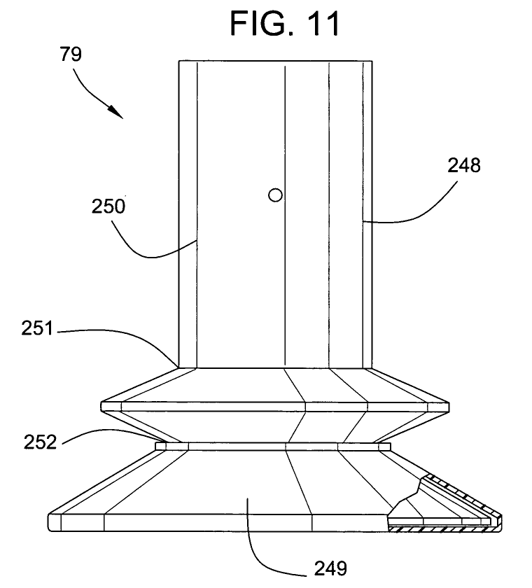

Referring to FIG. 11, the end effector 79 can include a body 248 and a boot 249 with the boot 249 being removably mounted to the body 248. The body 248 can include a coupler for mounting the body 248 to the linear motion actuator, the coupler in the form of a sleeve 250, and a pair of pleats 251, 252, which project radially from the cylindrical sleeve 250 and are adjacent to each other. The boot 249 can be removably mounted to the second pleat 252. In the illustrated example, the body 248 and the boot 249 are made from silicone. The body can be made from a 60-durometer silicone, and the boot can be made from a 70-durometer silicone. In other embodiments, the body 248 and the boot 249 can be made, for example, from a neoprene material or any other suitable resiliently flexible material. The body and the boot can be made from different materials and from materials which have different durometric values. For example, in other embodiments the body can be made from a 50-durometer silicone.

In use, making the boot from 70-durometer silicone was found to be helpful in preventing any adhesive from the labels from sticking to the boot and allowed the boot to retain its shape against the application of the vacuum source. It is contemplated that other materials can provide the same features and that the end effector can be made from different materials.

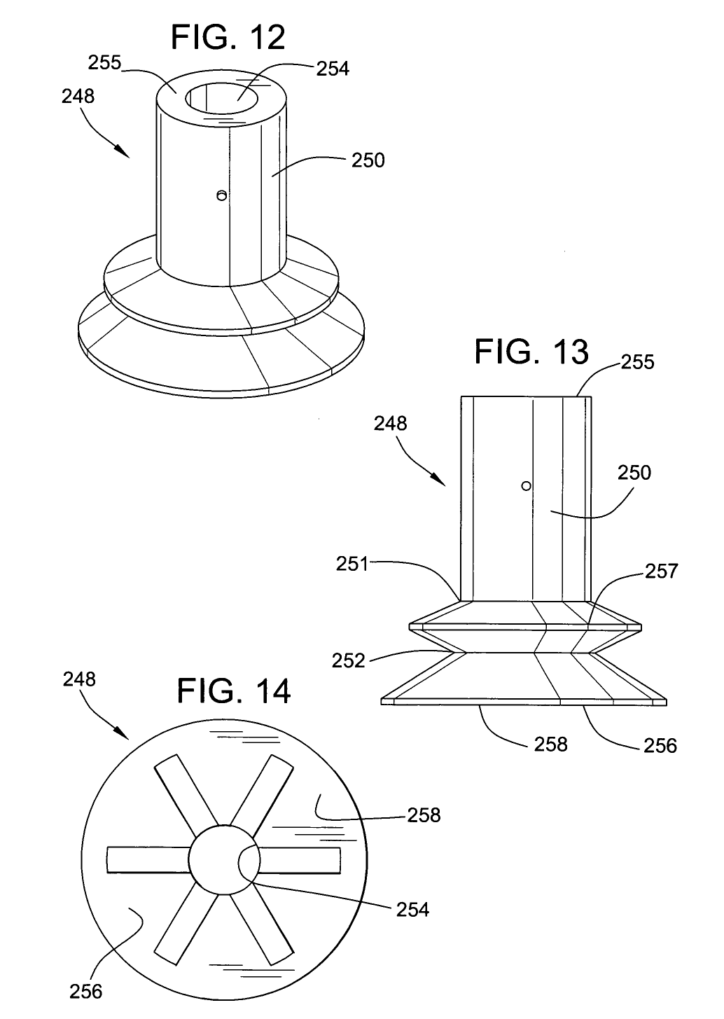

Referring to FIGS. 12-14, the body 248 is shown. The body 248 is hollow such that a passageway 254 extends therethrough from a proximal end 255 to a distal end 256. The passageway 254 can be provided so that the vacuum source and the pressurized air can act through the body 248. The pleats 251, 252 of the body 248 define a bellows portion 257 that can compress in response to the application of force upon it. The body 248 can include a flexible flange 258 that is in opposing relationship to the sleeve 250, the flange 258 being disposed at the distal end 156 thereof.

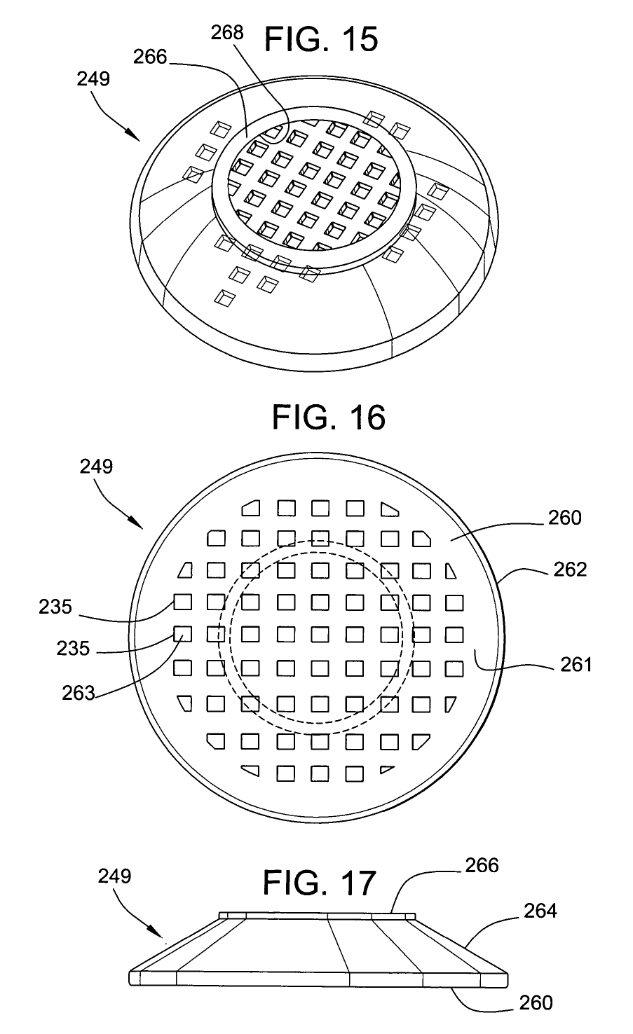

Referring to FIGS. 15-17, the boot 249 is shown. Referring to FIG. 16, the boot 249 can include a face 260 having a surface area 261 that is perforated by the plurality of holes 235. In this embodiment, the surface area 261 comprises the area bounded within a perimeter 262 of the face 260. In this embodiment, the perimeter 262 is substantially circular. Each hole 235 can define a void area 263 through which the vacuum source and the pressurized air can act upon a label in adjacent relationship thereto. The holes 235 need not be the same shape or size but, of course, can be. The percentage of the total area of the void area 263 to the surface area 261 of the face 260 can be between about 14% and about 20%, and is preferably about 17%.

Referring to FIG. 17, the boot 249 includes a tapered portion 264 that extends between the face 260 and a collar 266 opposing the face. The collar 266 defines an opening 268 (shown in FIG. 15) through which the flange of the body can be inserted. The tapered portion 264 can be configured to generally correspond to at least a portion of the flange to facilitate the retention of the boot 249 to the body. As such, the boot 249 can receive the body to removably retain the boot to the body.

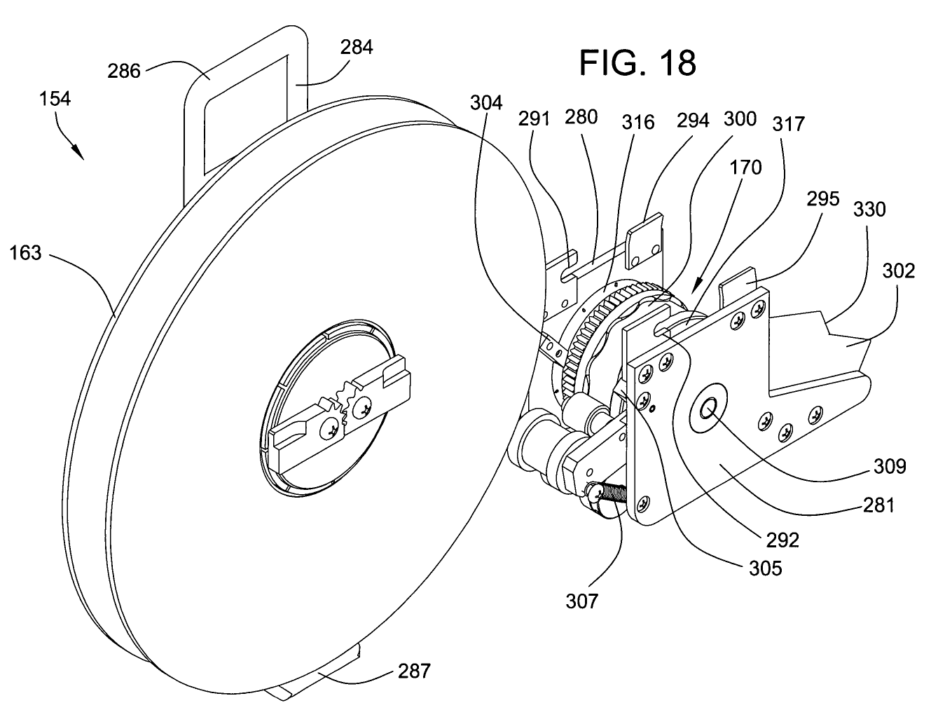

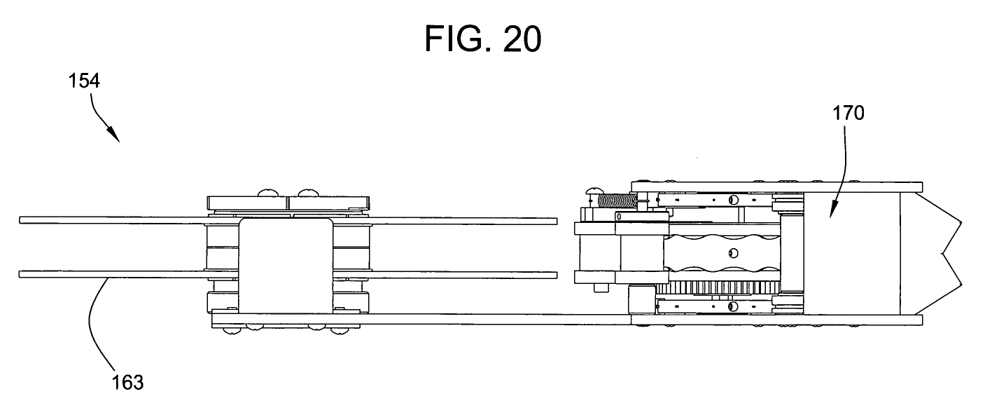

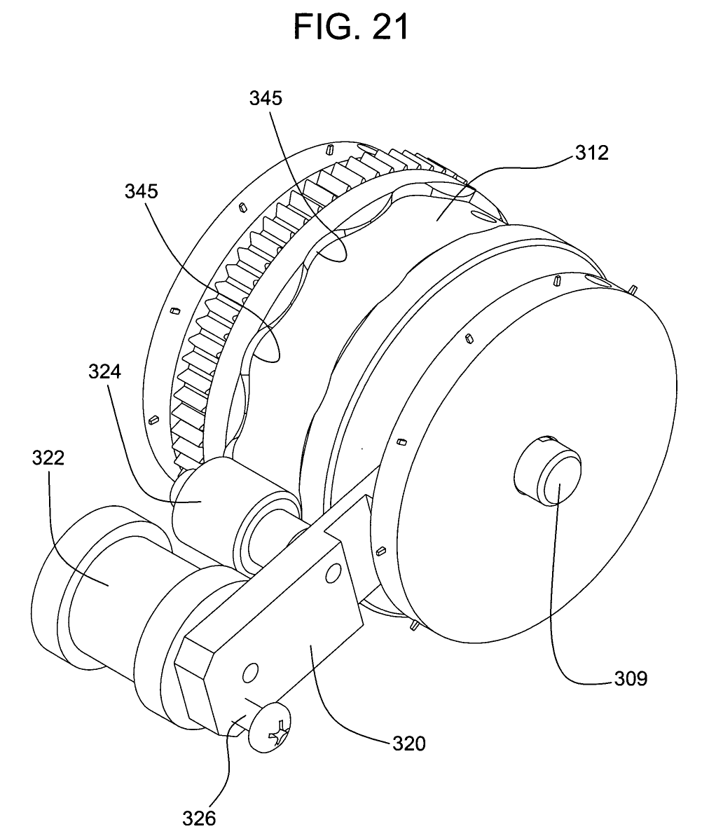

Referring to FIGS. 18-20, the cassette 154 is shown. The cassette 154 includes the reel 163 and the label feed mechanism 170. Referring to FIG. 18, the cassette 154 can include the label feed mechanism 170 housed between a pair of spaced-apart uprights 280, 281 which define a cavity therebetween. Extending from the first upright 280 is an arm 284 having a pair of handles 286, 287 projecting therefrom for convenient transportation of the cassette (FIG. 6 also). The arm 284 rotatably supports the reel 163 for bearing the carrier strip having labels thereon.

Referring to FIG. 18, the uprights 280, 281 each include a notch 291, 292 configured to receive the cassette hanger rod of the base and can include a detent for retentive engagement with one of the dowel pins of the same. A guide plate 294, 295 can also be mounted to each upright 280, 281 to facilitate the alignment of the cassette 154 with the base.

The label feed mechanism 170 can include a label advancement assembly 300, a separator plate 302, a pair of carrier strip wedges 304, 305, and a spring 307. The uprights 280, 281 are separated a distance substantially the same as the width of the separator plate 302. The uprights 280, 281 can each include a hole for receiving a respective end of a main shaft bushing 309 of the feed mechanism 170 which can support the label advancement assembly 300. The separator plate 302 is mounted to the uprights 280, 281 by a plurality of screws and is disposed in a forward position, extending from the uprights 280, 281. The carrier strip wedges 304, 305 are mounted to the uprights 280, 281, respectively, and facilitate the separation of the carrier strip into two halves after the labels have been removed therefrom. The spring 307 extends between the second upright 281 and the label advancement assembly 300 such that tension is applied to the label advancement assembly 300.

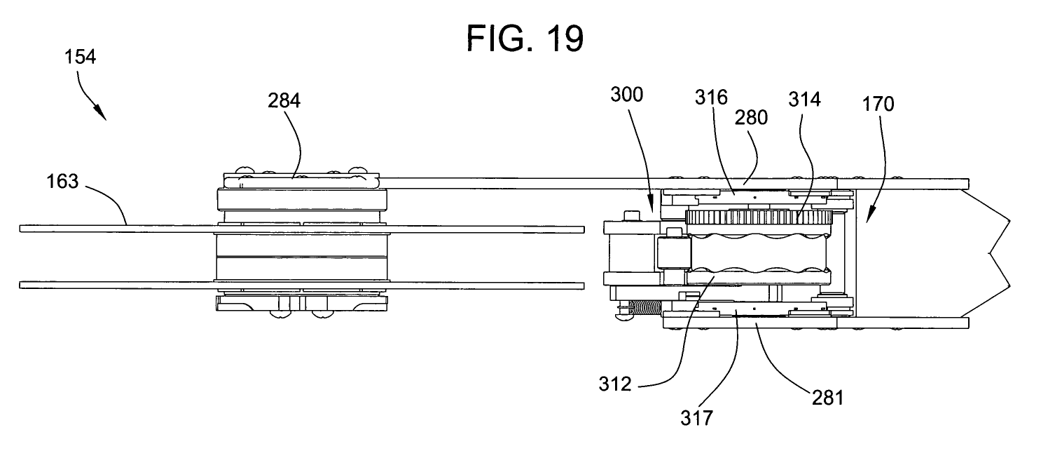

Referring to FIG. 19, the label advancement assembly 300 of the feed mechanism can include a hub 312, a cassette feed gear 314, and a pair of take-up pin wheels 316, 317 which all can be rotatable about the main shaft bushing 309 (FIG. 18). The cassette feed gear 314 can be operatively engaged with the feed gear 202 of the drive mechanism 182 of the base 152 (FIG. 10) such that operation of the drive mechanism causes the label advancement assembly 300 to rotate about the main shaft bushing.

The label carrier strip from the reel can be drawn around the hub 312 such that when the drive mechanism is operated to cause the cassette feed gear 314 to rotate, the hub 312 rotates, thereby unwinding the carrier strip from the reel 163. In this instance, the hub 312 has a depressed center section with sinusoidal side walls which engage complementarily shaped edges of the label carrier strip in order to facilitate the accurate positioning and the advancement of the carrier strip.

Referring to FIG. 21, a tensioner arm 320 can also be supported from the main shaft bushing 309. A dancer roller 322 is disposed at the projecting distal end of the tensioner arm 320. Intermediate of the tensioner arm 320 is disposed a hold down roller 324. The rollers 322, 324 are journaled to the tensioner arm 320 such that they are rotatable about an axis substantially parallel to the longitudinal axis of the main shaft bushing 242 about which components of the label advancement assembly 300 rotates. Extending from the tensioner arm 320 proximate the distal end thereof is a post 326 suitable for receiving one end of the spring 307 (FIG. 18) to pre-tension the tensioner arm 320. This roller-and-spring combination is an example of rollers useful for maintaining a predetermined amount of tension in the carrier strip as it advances through the feed mechanism to facilitate its accurate placement.

Referring to FIG. 18, the label feed mechanism 170 can advance the carrier strip from the reel 163 along the separator plate 302 which separates the labels from the carrier strip. The illustrated separator plate 302 is conveniently designed for the carrier strip that includes a line of weakness down its middle for forming separate halves. The labels can be attached over both halves of the carrier strip. To separate the labels from the carrier strip, the separator plate 302 includes a V-shaped notch 330 with each half of the carrier strip being drawn over a different side of the V-shaped notch. This causes the two halves of the carrier strip to follow divergent paths from each other, and also from the label thereby forcibly releasing at least a portion of the forward-most label from the label strip for pick up by the end effector. The label thus disposed in the pick position is disposed substantially below the end effector when the cassette 154 is mounted to the base. Each half of the separated carrier is then drawn back from the V-shaped notch 330 and wound around a respective take-up pin wheel 316, 317 and over a respective carrier strip wedge 304, 305. It will be appreciated by those skilled in the art that the present invention is not limited to the particular label feed and separation mechanism shown or to label strips having sinusoidal shaped edges.

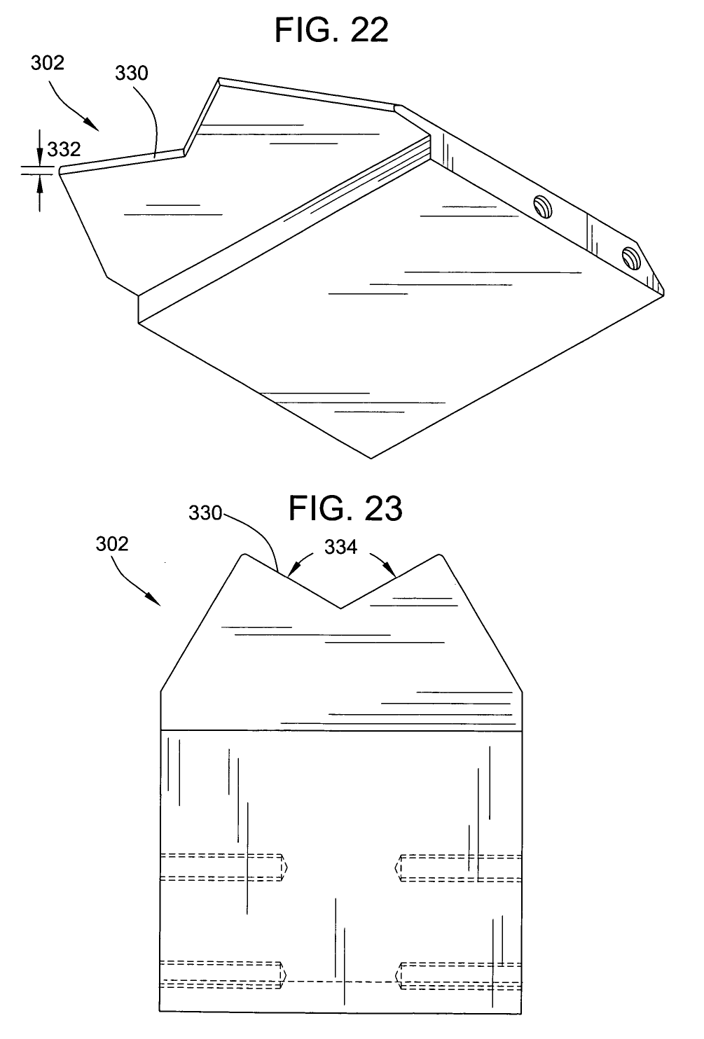

Referring to FIGS. 22 and 23, the separator plate 302 is shown. The separator 302 includes the V-shaped notch 330 convenient for drawing each half of the carrier strip over a different side of the V-shaped notch during operation of the feed mechanism to advance labels to the applicator head. Referring to FIG. 22, the separator plate 302 preferably has a thickness 332 such that the label can partially extend from the separator plate 302 in a substantially planar fashion without any substantial curling. The thickness 332 can be, for example, between about 0.062 and 0.100 inches, and is preferably about 0.068 inches. Referring to FIG. 23, the V-shaped notch 330 defines an angle 334 that is preferably greater than 90°. In some embodiments, the angle 334 can be about 120°. The separator plate 302 can be made from any suitable material, such as Delrin AF, for example.

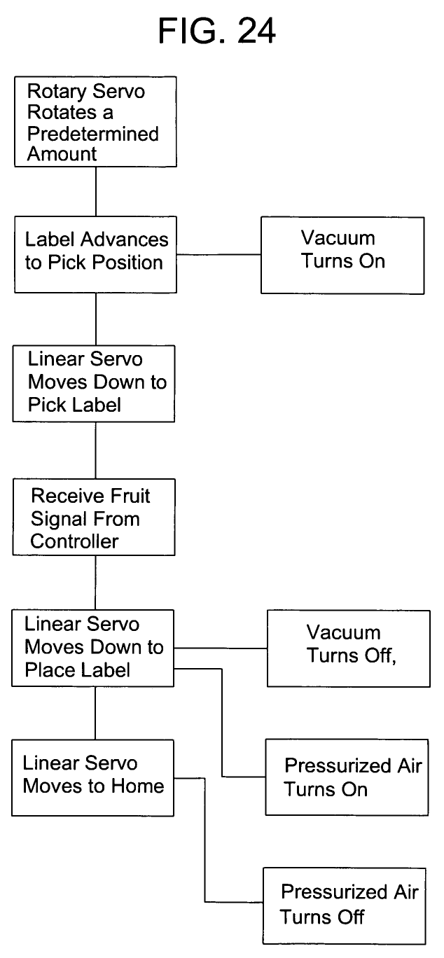

Referring to FIG. 24, an embodiment of using the labeler 210 of FIG. 13 is shown. In other embodiments, the labeler 210 can be used differently.

In another aspect of the invention, the controller can be used to configure the drive mechanism such that it can be used with cassettes having supplies of labels with different pitches. Label pitch refers to the distance between center lines of two adjacent labels disposed on the carrier strip. In the industry, typical label pitches include ⅝″ pitch, ¾″ pitch, and 1″ pitch, for example. A cassette that is loaded with labels having a 1″ pitch must advance the carrier strip ¼″ more per label applied than a cassette loaded with ¾″ pitch labels, for example. Cassettes loaded with different pitch sizes can have different advancement mechanisms in that the hubs are different.

Referring to FIG. 21, the sinusoidal side walls of the hub 312 define a plurality of scalloped label segments 345 where a label on the carrier strip can fit such that the carrier strip can be pulled from the reel as the hub 312 rotates. As the size of the label increases, so does the size of the label segment 345. Accordingly, a typical hub suitable for use with a 1″ pitch label may have eight such segments so that the hub must rotate 45° to move the carrier strip the requisite 1″ to advance the carrier strip so that the next label on the strip is in the pick position. On the other hand, a typical hub suitable for use with a ¾″ pitch label may have ten such segments so that a similarly-sized hub need only rotate 36° to move the carrier strip the requisite ¾″ to advance the carrier strip so that the next label on the strip is in the pick position. And so, such a hub for use with a ⅝″ pitch label would have twelve label segments and rotate 30° to move the carrier strip the requisite ⅝″.

Frequently, prior labelers would have to change drive mechanisms as well as the cassette advancement mechanism when using labels of different pitches. According to the present invention, the controller can be used to vary the number of stepper counts that the stepper motor 196 undergoes when operating so that the drive mechanism 182 of the base can be used with cassettes having different label advancement assembly with hubs containing different numbers of scalloped label segments. The controller can have a stepper count database containing stepper count values for different label pitches. The user can select a stepper count value for the particular label pitch he is using in the labeler by use of the operator interface. Upon receiving an input signal from the operator interface, the controller can pull the stepper count value from the database according to the label pitch so selected, and change the stepper count of the stepper motor 196 of the drive mechanism such that the base can be used with a cassette loaded with a supply of labels having the selected label pitch.

In one embodiment, the following formulas can be used to compute the stepper count value for a particular label pitch:

$$\frac{\begin{matrix}Stepper \\ Pulses\end{matrix}}{\begin{matrix}Revolution of \\ Drive Gear\end{matrix}} \times \frac{\begin{matrix}Pitch Diameter of \\ Intermediate Gear\end{matrix}}{\begin{matrix}Pitch Diameter of \\ Drive Gear\end{matrix}} = \frac{\begin{matrix}Stepper \\ Pulses\end{matrix}}{\begin{matrix}Revolution of \\ Intermediate Gear\end{matrix}}$$

$$\frac{\begin{matrix}Stepper \\ Pulses\end{matrix}}{\begin{matrix}Revolution of \\ Intermediate Gear\end{matrix}} \times \frac{\begin{matrix}Pitch Diameter of \\ Feed Gear\end{matrix}}{\begin{matrix}Pitch Diameter of \\ Intermediate Gear\end{matrix}} = \frac{\begin{matrix}Stepper \\ Pulses\end{matrix}}{\begin{matrix}Revolution of \\ Feed Gear\end{matrix}}$$

$$\frac{\begin{matrix}Stepper \\ Pulses\end{matrix}}{\begin{matrix}Revolution of \\ Feed Gear\end{matrix}} \times \frac{1 Revolution}{360 °} = \frac{\begin{matrix}Stepper \\ Pulses\end{matrix}}{\begin{matrix}Feed Gear \\ Degree\end{matrix}}$$

$$\frac{\begin{matrix}Stepper \\ Pulses\end{matrix}}{\begin{matrix}Feed Gear \\ Degree\end{matrix}} \times Pitch Angle = \begin{matrix}Stepper \\ Pulses\end{matrix}$$

$$\begin{matrix}Stepper \\ Pulses\end{matrix} \times Controller Scale = \begin{matrix}Stepper \\ Counts\end{matrix}$$

where,
stepper pulses/revolution of drive gear, refers to the number of pulses the stepper undergoes to make the drive gear undergo a complete revolution;
pitch diameter of intermediate gear/pitch diameter of drive gear, refers to the gear ratio between the drive and intermediate gears of the drive mechanism;
stepper pulses/revolution of intermediate gear, refers to the number of pulses the stepper undergoes to make the intermediate gear undergo a complete revolution;
pitch diameter of feed gear/pitch diameter of intermediate gear, refers to the gear ratio between the intermediate and feed gears of the drive mechanism;
stepper pulses/revolution of feed gear, refers to the number of pulses the stepper undergoes to make the feed gear undergo a complete revolution;
1 revolution/360°, refers to the concept that I revolution is equal to 360° and is being used to convert revolutions to degrees;
stepper pulses/feed gear degree, refers to the number of pulses the stepper undergoes to make the feed gear rotate 1°;
pitch angle, refers to the angle of rotation the hub of the particular advancement mechanism undergoes for the label pitch selected (e.g., 36° for ¾″ pitch, 30° for ⅝″ pitch, and 45° for 1″ pitch);
   controller scale, refers to a coefficient attributable to the particular controller used to control the stepper motor; and
   stepper counts, refers to the number of pulses the stepper motor undergoes to cause the feed gear to rotate the necessary amount to accurately advance the carrier strip to the next label on the strip for the selected label pitch.

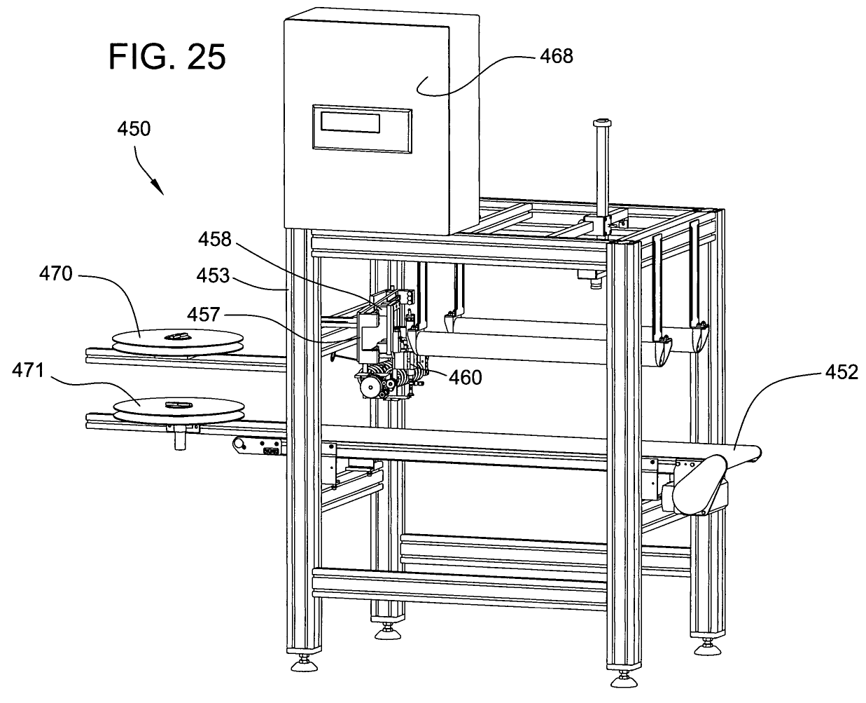

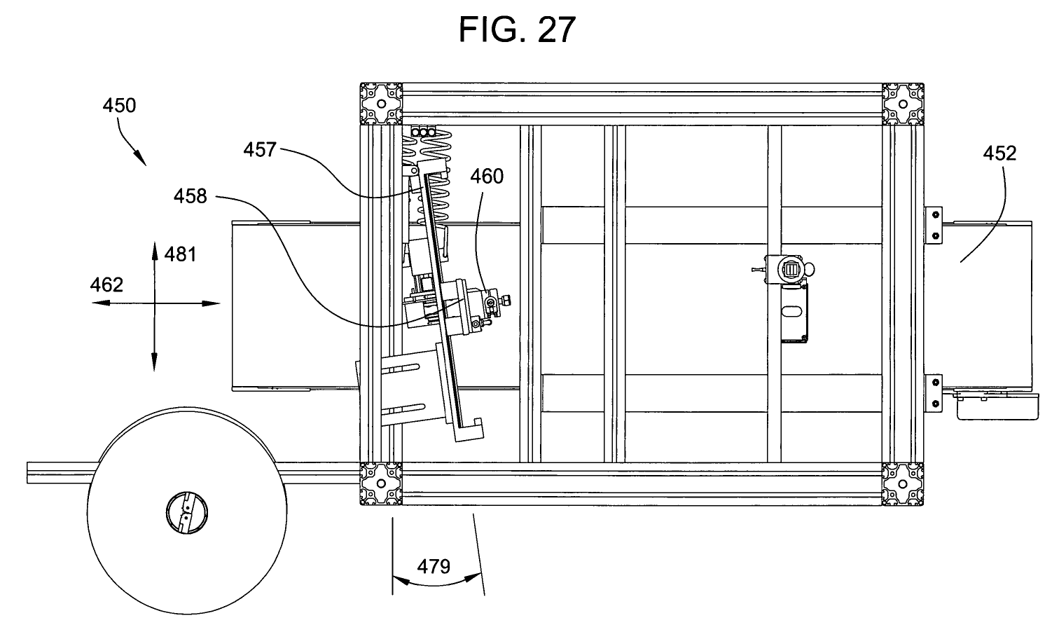

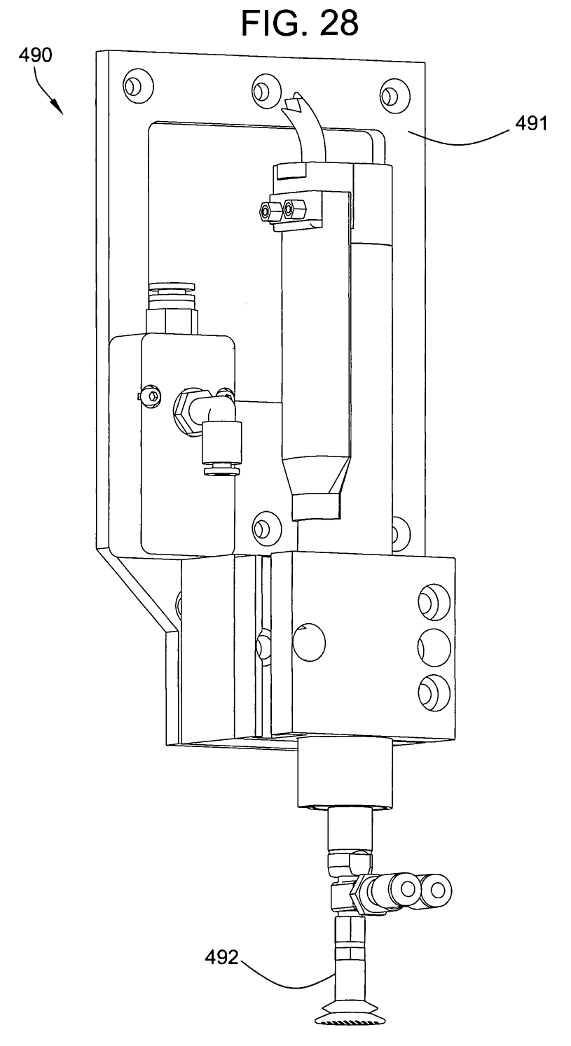

Referring to FIGS. 25-27, another embodiment of a labeler system 450 useful for labeling a tray which contains multiple rows of receptacles for receiving fruit or other objects for labeling according to the present invention is shown. Referring to FIG. 25, the labeler system 450 can include a conveyor 452 for moving the trays into position for applying labels to the fruit in the trays and a frame 453 for supporting a track 457, a carriage 458, and a labeler 460 over the conveyor 452. The conveyor 452 can move the tray along an object axis 462 (FIG. 27). The track 457 can extend across the conveyor 452. The carriage 458 is reciprocally movable along the track 457. A servomotor, such as a linear servo from Trilogy, for example, can be provided to selectively move the carriage along the track. The labeler 460 is mounted to the carriage 458.

Referring to FIG. 25, the labeler system 450 can include a control unit 468 which moves the labeler 460 along a predetermined path upon either receiving an instruction from an operator or from some other source, for example. The predetermined path can correspond to a particular type of tray, for example, such that the labeler can be placed in a plurality of placement positions for labeling each piece of fruit contained in the tray. The control unit 468 can monitor the location of the tray relative to the labeler as described above in connection with the labeler system 50 of FIG. 1, for example.

A pair of reels 470, 471 can be provided, one for dispensing labels on a carrier strip and the other for taking up the spent carrier strip after the label has been peeled therefrom by the applicator head. In some embodiments, a vacuum source connected to a tube can be provided for the disposing of the spent carrier strip. The tube can include an open end disposed near the applicator head. The vacuum source can provide suction to urge the spent carrier strip through the tube to a collection area.

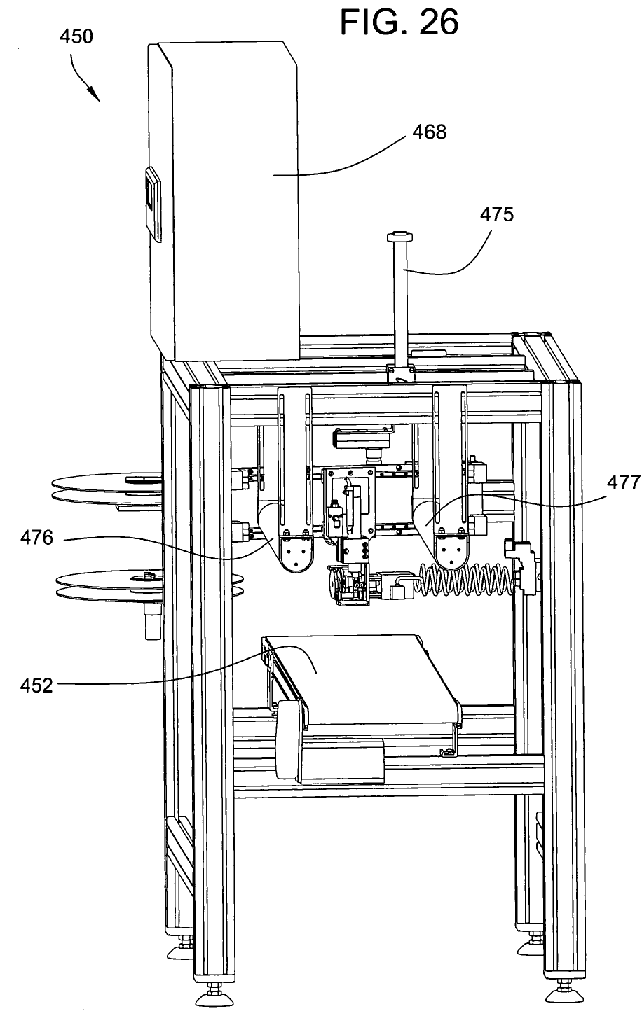

Referring to FIG. 26, the labeler system 450 can include a vision system 475 useful in identifying the object or objects to be labeled. The vision system 475 can be electrically connected to the control unit 468 to provide an input signal containing visual data thereto. The control unit can, in turn, move the labeler 460 in response to the visual data obtained from the vision system. A pair of high-frequency lights 476, 477 can be positioned over the conveyor to facilitate the vision system's acquiring visual data.

In some embodiments, the vision system can be used to identify fruit randomly spread over an open conveyor. The vision system can assign coordinates to the identified fruit which are sent to the controller 468. The controller can direct the labeler to the determined coordinates to apply labels thereto. In other embodiments, the vision system can be used to recognize different tray configurations and in response deliver a predetermined travel path to the servo system for moving the labeler therethrough to apply labels to the fruit loaded in the identified tray.

Referring to FIG. 27, the labeler 460 can move with respect to the object to be labeled in a direction generally transverse to the direction of travel of the object to be labeled. The track 457 can be disposed at an angle 479 to a transverse axis 481, which is perpendicular to the object axis 462, to provide time within which the carriage 458 and the labeler 460 can move along the track 457 while still being able to label a series of objects aligned with each other along the transverse axis 481 in the tray.

Referring to FIG. 28, the labeler includes an applicator head 490 that can be substantially similar to the applicator head of the labeler 62 of FIG. 5. The applicator head includes a mounting plate 491 for mounting the applicator head to the carriage. The applicator head 490 can include an end effector 492 that is reciprocally movable along an applicator axis that can be mutually perpendicular to the object axis and the transverse axis of the labeler system 450.

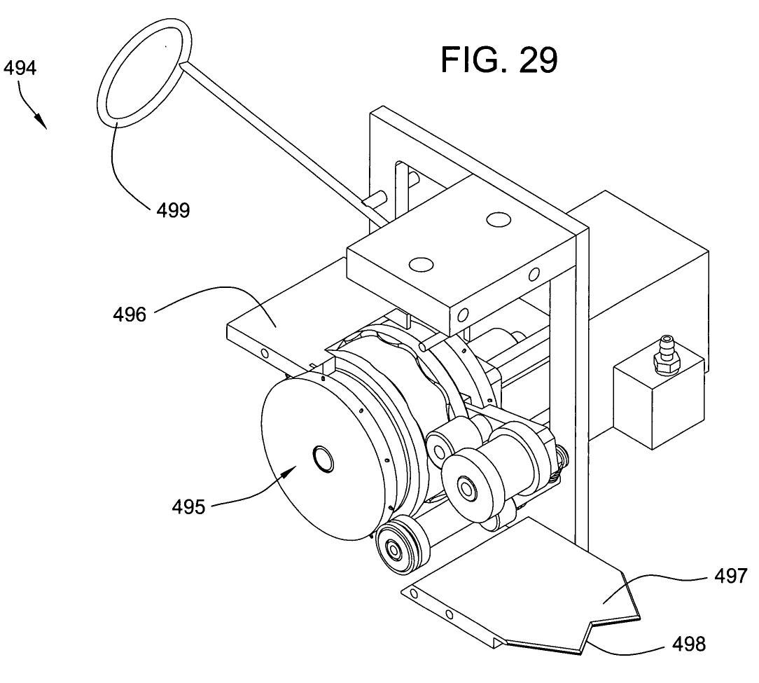

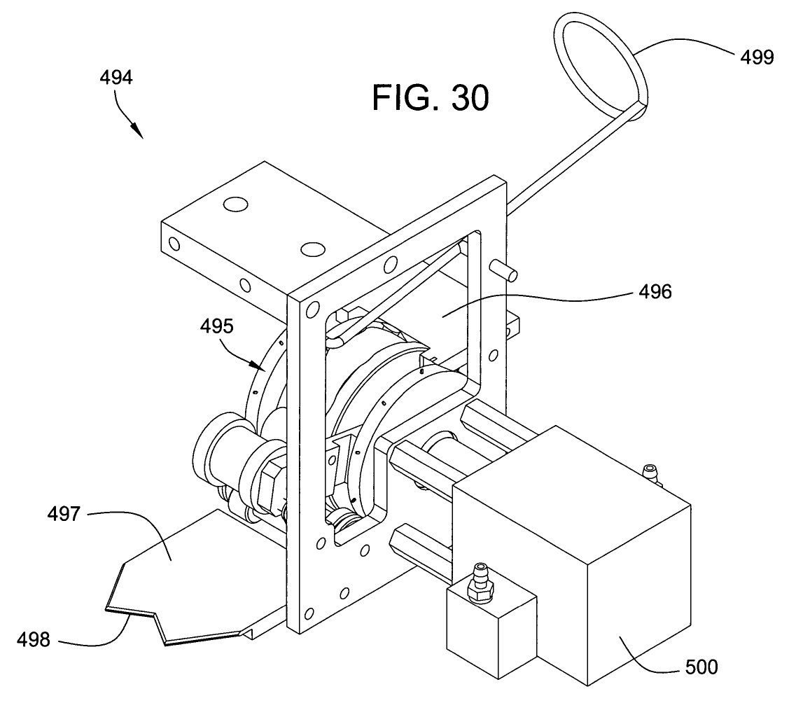

Referring to FIGS. 29 and 30, the labeler can include a feed mechanism 494 for advancing labels to the applicator head 490 of FIG. 28. The feed mechanism 494 can include an advancement assembly 495, a stripper plate 496, a separator 497 having a V-shaped notch 498, and a carrier strip guide 499 for guiding the spent carrier strip back to the take-up reel and preventing it from becoming tangled as the labeler moves along the track. The advancement assembly 495 can be substantially similar to the advancement assembly 300 shown in FIG. 21. The advancement mechanism 495 can be driven by an air indexer 500.

The inventive labeler technology can make labeling more productive and reliable and provide greater flexibility for the end user. Further, the cost of such a labeler can be less than conventional bellows-type labelers, thereby lowering the barrier to entry into the labeling market for packing houses.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise indicated.

While the invention is described herein in connection with certain preferred embodiments, there is no intent to limit the present invention to those embodiments. On the contrary, it is recognized that various changes and modifications to the described embodiments will be apparent to those skilled in the art upon reading the foregoing description, and that such changes and modifications may be made without departing from the spirit and scope of the present invention. The inventors expect skilled artisans to employ such variations as appropriate, and the inventors intend for the invention to be practiced otherwise than as specifically described herein. Accordingly, the intent is to cover all alternatives, modifications, and equivalents included within the spirit and scope of the invention. Moreover, any combination of the above-described elements in all possible variations thereof is encompassed by the invention unless otherwise indicated herein or otherwise clearly contradicted by context.

What is claimed is:

1. A labeler for applying labels to articles transported by a conveyor comprising:
a label feed mechanism for feeding a supply of labels to a pick position;
a vacuum source, the vacuum source being selectively operable to provide a vacuum;
an applicator head, the applicator head operably arranged with the label feed mechanism to selectively pick up a label from the pick position, the applicator head connected to the vacuum source to selectively retain the label on the applicator head, the applicator head having an end effector which is movable in a reciprocal fashion along a linear applicator axis over a range of travel between at least the pick position and a label application position wherein the label retained on the applicator head is transferable to the article being labeled.

2. The labeler of claim 1, wherein the supply of labels is supported by a carrier strip, the labeler further comprising:
a label cassette for storing the supply of labels, the label cassette including a rotatable reel, the carrier strip wound on the reel, the carrier strip engaged with the label feed mechanism.

3. The labeler of claim 2, further comprising:
a separator plate for separating the labels from the carrier strip.

4. The labeler of claim 3, wherein the carrier strip includes a line of weakness extending longitudinally along the strip to define first and second halves of the strip, and the separator plate includes a notch, the notch disposed at a forward end of the label feed mechanism, the notch having first and second edges arranged in a V-shape, the carrier strip wrapped around the V-shaped notch such that the first and second halves of the strip are respectively drawn over the first and second edges of the notch when the feed mechanism is operated, the V-shaped notch disposed such that the forward-most label is disposed in the pick position as the forward-most label is drawn through the notch.

5. The labeler of claim 4, wherein the V-shaped notch is configured such that at least a portion of the forward-most label is released from the carrier strip when the forward-most label is in the pick position.

6. The labeler of claim 4, wherein the V-shaped notch defines an angle greater than about 90°.

7. The labeler of claim 6, wherein the angle is about 120°.

8. The labeler of claim 1, further comprising:
a drive mechanism to drive the label feed mechanism.

9. The labeler of claim 8, wherein the drive mechanism comprises at least one electronically-controlled motor.

10. The labeler of claim 9, wherein the electronically-controlled motor comprises an air indexer.

11. The labeler of claim 9, wherein the electronically-controlled motor comprises a stepper motor.

12. The labeler of claim 9, wherein the electronically-controlled motor comprises a servo motor.

13. The labeler of claim 8, further comprising:
a controller connected to the drive mechanism and the applicator head, the controller selectively operating the drive mechanism and moving the end effector to permit the end effector to effect the picking up of a label in the pick position and the depositing of the label retained thereon on an article positioned at the label application position.

14. The labeler of claim 13, wherein the controller is connected to the vacuum source, the controller selectively operating the vacuum source such that the vacuum source is operating to provide a vacuum at the applicator head when the end effector is in the pick position and when the end effector is moving from the pick position toward the label application position and such that the vacuum source is not operating when the end effector is in the label application position.

15. The labeler of claim 14, further comprising:
a sensor for detecting an article in a predetermined location and providing an indication of such detection, the sensor being connected to the controller;
wherein the controller selectively controls the drive mechanism, the applicator head, and the vacuum source upon receipt of an indication from the sensor.

16. The labeler of claim 13, further comprising:
an application sensor for detecting when the end effector contacts the article to be labeled and providing an indication of such detection, the sensor being connected to the controller;
wherein the controller selectively controls the applicator head and the vacuum source upon receipt of the indication from the application sensor such that the end effector stops moving and the vacuum source turns off.

17. The labeler of claim 1, wherein the applicator head includes a linear motion actuator for reciprocally moving the end effector along the applicator axis.

18. The labeler of claim 17, wherein the linear motion actuator includes a reciprocally movable piston having a distal end, the end effector being mounted to the distal end of the piston.

19. The labeler of claim 1, wherein the conveyor transports the articles along a conveyor axis, the applicator axis of the applicator head being disposed at a predetermined angle with respect to the conveyor axis.

20. The labeler of claim 19, wherein the applicator axis is substantially perpendicular to the conveyor axis.

21. The labeler of claim 1, wherein the end effector is reciprocally movable along the applicator axis over a range of travel between a home position and the label application position, the pick position being disposed between the home position and the label application position.

22. The labeler of claim 1, wherein the end effector includes a plurality of holes therein for allowing the vacuum source to act upon the label in the pick position when the end effector is adjacent to said label.

23. The labeler of claim 22, wherein the end effector includes a face, the holes being disposed on the face.

24. The labeler of claim 23, wherein the face has a face surface area, each hole has a void surface area, and the percentage of the total of the void surface areas to the face surface area is between about 14% and about 20%.

25. The labeler of claim 24, wherein the percentage is about 17%.

26. The labeler of claim 1, wherein the end effector includes a bellows portion.

27. The labeler of claim 23, wherein the end effector includes a bellows portion.

28. The labeler of claim 1, wherein the end effector comprises silicone.

29. The labeler of claim 1, wherein the end effector comprises a multi-piece construction.

30. The labeler of claim 29, wherein the end effector comprises a body and a boot, the boot mounted to the body.

31. The labeler of claim 30, wherein the body includes a bellows portion and a passageway for allowing the vacuum source to act therethrough, and the boot includes a face having a plurality of holes therein for allowing the vacuum source to act upon the label in the pick position when the end effector is adjacent to said label.

32. The labeler of claim 31, wherein the body includes a coupler for mounting the end effector and a flange, the bellows portion disposed between the coupler and the flange, the boot being mounted to the flange.

33. The labeler of claim 32, wherein the coupler comprises a sleeve.

34. The labeler of claim 30, wherein the body comprises silicone and the boot comprises silicone.

35. The labeler of claim 34, wherein the body has a first durometric value, and the boot has a second durometric value.

36. The labeler of claim 35, wherein the first and second durometric values are different from each other.

37. The labeler of claim 1, wherein the first durometric value is about 60, and the second durometric value is about 70.

38. The labeler of claim 1, further comprising:
an air source, the air source being selectively operable to provide pressurized air;
wherein the applicator head is connected to the air source to selectively urge a label retained on the applicator head to separate from the applicator head.

39. The labeler of claim 38, further comprising:
a controller connected to the drive mechanism and the applicator head, the controller selectively operating the drive mechanism and moving the end effector to permit the end effector to effect the picking up of a label in the pick position and the depositing of the label retained thereon on an article positioned at the label application position;
wherein the controller is connected to the air source, the controller selectively operating the air source such that the air source is operating to provide pressurized air at the applicator head when the end effector is in the label application position.

40. The labeler of claim 39, wherein the controller selectively operates the air source such that the air source is not operating when the end effector moves from the label pick position to the label application position

41. The labeler of claim 1, further comprising:
a second label feed mechanism for feeding the supply of labels to a second pick position;
a second applicator head, the second applicator head connected to the vacuum source and operably arranged with the second label feed mechanism to selectively pick up a label from the second pick position and selectively retain the label on the second applicator head, the second applicator head having an end effector which is movable in a reciprocal fashion along a second linear applicator axis over a range of travel between at least the second pick position and a second label application position wherein the label retained on the second applicator head is transferable to the second article being labeled;
a frame for supporting the first and second applicator heads over the conveyor, the first and second applicator heads being in spaced relationship with each other.

42. The labeler of claim 41, wherein the conveyor has a direction of travel defining an object axis and a transverse axis which is perpendicular to the object axis, and the frame includes a track, the first and second applicator heads movably supported by the track for adjusting the position of the first and second applicator heads along the transverse axis.

43. The labeler of claim 42, wherein the first and second applicator heads are movable with respect to the conveyor and to each other.

44. The labeler of claim 41, wherein the supply of labels is supported by a carrier strip, the labeler further comprising:
a pair of label cassettes for storing the supply of labels, the first label cassette including a first rotatable reel, a first portion of the carrier strip wound on the first reel, the first portion of the carrier strip engaged with the first label feed mechanism, and the second label cassette including a second rotatable reel, a second portion of the carrier strip wound on the second reel, the second portion of the carrier strip engaged with the second label feed mechanism.

45. The labeler of claim 41, further comprising:
a third label feed mechanism and a third applicator head;
a fourth label feed mechanism and a fourth applicator head.

46. The labeler of claim 45, wherein the frame includes a second track, the second track in spaced relationship with the first track along the object axis, the third and fourth applicator heads movably supported by the second track for adjusting the position of the third and fourth applicator heads along the transverse axis.

47. The labeler of claim 1, wherein the conveyor has a direction of travel defining an object axis and a transverse axis which is perpendicular to the object axis, the conveyor having a first edge and a second edge both extending along the object axis, the labeler further comprising:
a frame for supporting the applicator head over the conveyor, the frame including a track extending between the first edge and the second edge;
a carriage, the carriage being reciprocally movably mounted to the track, the carriage supporting the applicator head.

48. The labeler of claim 47, wherein the carriage is reciprocally movable over a range of travel at least between the first and second edges of the conveyor.

49. The labeler of claim 47, further comprising:
a motor for moving the carriage along the track.

50. The labeler of claim 47, further comprising:
a drive mechanism to drive the label feed mechanism.

51. The labeler of claim 50, further comprising:
a controller connected to the drive mechanism and the applicator head, the controller selectively operating the drive mechanism and moving the end effector along the applicator axis to permit the end effector to effect the picking up of a label in the pick position and the depositing of the label retained thereon on an article positioned at the label application position.

52. The labeler of claim 51, further comprising:
a motor for moving the carriage along the track, the controller selectively operating the motor to move the end effector along the track in a predetermined path.

53. The labeler of claim 52, wherein the controller selectively operates the drive mechanism and the end effector to permit the end effector to pick up and deposit a plurality of labels during movement of the end effector along the predetermined path such that a corresponding plurality of articles moving on the conveyor along the object axis are labeled.

54. The labeler of claim 52, wherein the controller includes a database containing a plurality of predetermined travel paths for the end effector and a user input interface for allowing a user to select one of the predetermined travel paths for execution, the controller executing one of the predetermined travel paths upon receiving an indication from the user input interface.

55. The labeler of claim 51, further comprising:
a motor for moving the carriage along the track;
a vision system for identifying an object or objects on the conveyor to be labeled, the vision system operably connected to the controller such that the vision system sends visual data to the controller;
wherein the controller selectively operating the motor to move the end effector along the track in response to the visual data obtained from the vision system.

56. The labeler of claim 47, wherein the track extends along a track axis, the track axis being in non-parallel relationship with the transverse axis of the conveyor.

57. A labeler for applying labels to articles transported by a conveyor comprising: a label feed mechanism for feeding a supply of labels to a pick position and an applicator head, the applicator head operably arranged with the label feed mechanism to selectively pick up a label from the pick position and selectively retain the label on the applicator head, the applicator head having an end effector which is movable in a reciprocal fashion along a linear applicator axis over a range of travel between at least the pick position and a label application position wherein the label retained on the applicator head is transferable to the article being labeled.

58. A label applicator for applying labels to articles comprising:
a linear motion actuator;
an end effector, the end effector mounted to the linear motion actuator such that the end effector is movable in a reciprocal fashion along a linear applicator axis over a range of travel between at least a pick position, wherein the end effector can pick up a label, and a label application position, wherein the label retained on the end effector is transferable to the article being labeled.

59. A labeler for applying labels to articles transported by a conveyor, wherein the conveyor has a direction of travel defining an object axis and a transverse axis which is perpendicular to the object axis, the conveyor having a first edge and a second edge both extending along the object axis, the labeler further comprising:
a label feed mechanism for feeding a supply of labels to a pick position;
a vacuum source, the vacuum source being selectively operable to provide a vacuum;
an applicator head, the applicator head operably arranged with the label feed mechanism to selectively pick up a label from the pick position, the applicator head connected to the vacuum source to selectively retain the label on the applicator head, the applicator head having an end effector which is movable to a label application position wherein the label retained on the applicator head is transferable to the article being labeled;
a frame for supporting the applicator head over the conveyor, the frame including a track extending between the first edge and the second edge;
a carriage, the carriage being reciprocally movably mounted to the track, the carriage supporting the applicator head.

60. A labeler system for applying labels of different sizes to articles, the labeler comprising:
a first label feed mechanism for successively feeding a first supply of labels to a pick position, the first supply of labels having a first size;
a second label feed mechanism for successively feeding a second supply of labels to a pick position, the second supply of labels having a second size, the second size being different than the first size;
a drive mechanism interchangeably engageable with the first label feed mechanism and the second feed mechanism for advancing the respective supply of labels therethrough;
an applicator head, the applicator head operably arranged with the label feed mechanism to selectively pick up a label from the pick position and move it to a label application position wherein the label retained on the applicator head is transferable to the article being labeled;
a controller operably engaged with the drive mechanism, the controller including an interface for sending a label signal indicating which of the label feed mechanisms is engaged with the drive mechanism, the controller selectively controlling the drive mechanism to deliver successively to the pick position the respective supply of labels of the first label feed mechanism and the second feed mechanism based upon the label signal.

61. The labeler system of claim 60, wherein the first label feed mechanisms includes a first hub, the first hub sized to receive the first supply of labels, the first hub configured such that it rotates through a first angle to advance the first supply of labels a first distance such that the next label is disposed in the pick position, the second label feed mechanisms includes a second hub, the second hub sized to receive the second supply of labels, the second hub configured such that it rotates through a second angle to advance the second supply of labels a second distance such that the next label is disposed in the pick position, the first angle being different than the second angle, the first distance being different than the second distance, the controller selectively controlling the drive mechanism such that the first and second hubs rotate through the first and second angles, respectively, based upon the label signal.

62. The labeler system of claim 61, wherein the first angle is one of 45°, 36°, and 30°, and the first distance is one of 1″, ¾″, and ⅝″, respectively.

63. The labeler system of claim 60, wherein the drive mechanism includes a stepper motor interchangeably engageable with the first and second label feed mechanisms to advance the respective first and second supply of labels, the controller operable to set the number of stepper counts that the stepper motor undergoes when operating depending upon the label signal.
